(19) United States
(12) Patent Application Publication
(10) Pub. No.: US 2008/0223657 A1
(43) Pub. Date: Sep. 18, 2008

(54) Ladder Boot

(76) Inventors: Kevin Robert Keefe, Schuylerville, NY (US); Martha Dinge Keefe, Schuylerville, NY (US)

Correspondence Address: Kevin Keefe, 229 Broad St., Schuylerville, NY, 12871, US

(21) Appl. No.: 12/074,300

(22) Filed: Mar. 3, 2008

Related U.S. Application Data
(60) Provisional application No. 60/906,293, filed on Mar. 12, 2007.

(51) Int. Cl. E06C 7/42

(52) U.S. Cl. 182/108

(57) ABSTRACT

The present invention is a tool or apparatus relating to the safety of an individual using a ladder. The apparatus is simple in design and use being crafted of a single piece of metal shaped into a three sided open ended box. The middle side being extended into a point to be inserted into the ground. In the preferred form, it is used in a pair or set of two, positioned at the base of a ladder, one at each foot. The apparatus need not be attached to the ladder by any means, merely inserted into the ground surrounding the foot so as to prevent the foot from slipping or “kicking” out and causing the ladder to slip.

### BACKGROUND

The invention was designed to minimize accidents when using ladders in construction or repair on dirt, grass or gravel as it keeps the bottom of the ladder from shifting or kicking out thus preventing the ladder from sliding away from the structure it is leaning against.

### SPECIFICATION

The invention is made from a single piece of flat metal formed into an “open ended” box with three sides. The right and left sides being opposite and equal in size and shape. The middle or front side is longer with the bottom extended to form a diamond pointed wedge. When a ladder is in use, ie. placed up against the side of a building or wall, the wedge is placed up against the end of the ladder stile where the foot of the ladder hits the ground, the two sides extending back so that they form a box around the foot of the ladder. By means of pressure by foot or hammer, the tip of the wedge is forced into the ground. Such placement should keep the bottom ends of the ladder from moving. It is designed to be used in pairs, one for each foot of the ladder when the ladder is in the upright position

### DESCRIPTION OF DRAWINGS

FIG. 1 shows the ladder boot(s) 1b in use. For illustrative purposes they are placed at the feet of a ladder 1a which is not part of the claimed design. The points 1c, shown in broken lines, are below ground level 1d shown in long broken lines.

FIG. 2 is a front view showing the middle or long pointed side of the invention.

FIG. 3 is a left side perspective view showing the shorter sides that extend from the front to form the box shape of the invention.

FIG. 4 is a rear perspective view looking “inside” the boot from the back of the invention.

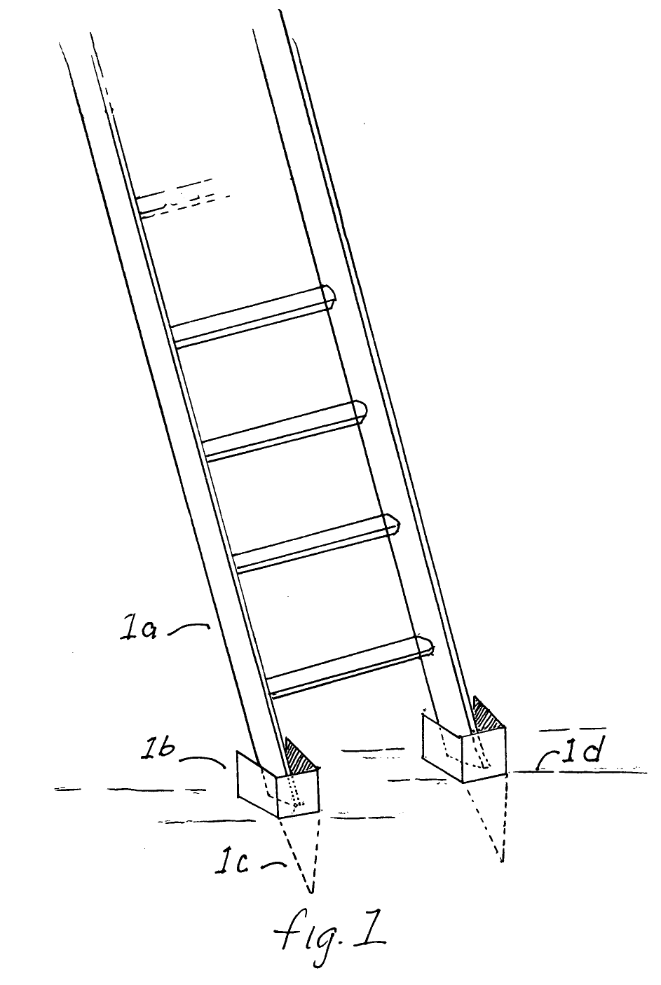

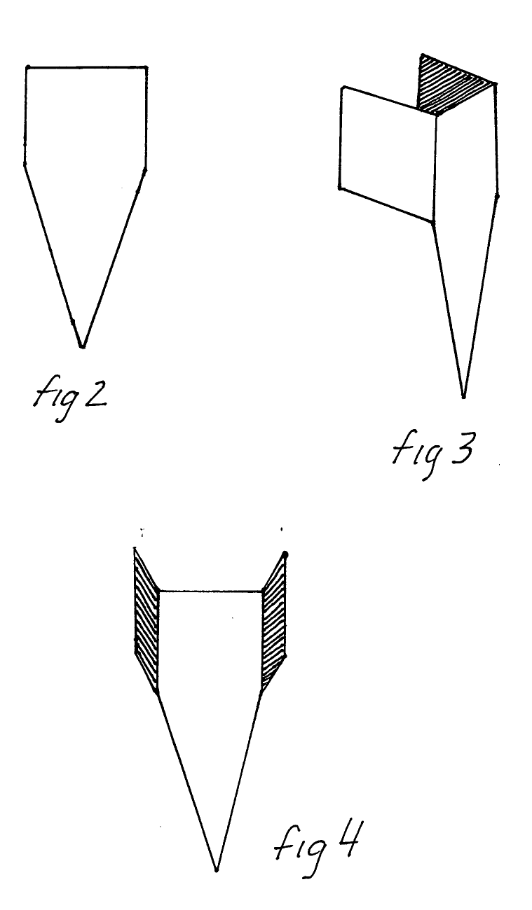

What is claimed is:

1. A support accessory or brace designed to be used with any standard wood, aluminum or fiberglass extension ladder.

2. The accessory of claim 1 is inserted into the ground at the foot of a ladder to provide secure footing for the base of the ladder, ie to prevent the “legs” or stiles from shifting or “kicking out” when a person is climbing up or working from it.

3. The accessory of claim 1 is designed to be used in pairs, one for each of the two feet of a ladder.
